(19) United States
(12) Patent Application Publication
(10) Pub. No.: US 2022/0217990 A1
(43) Pub. Date: Jul. 14, 2022

(54) OILY CONFECTIONERY AND METHOD FOR MANUFACTURING SAME

(71) Applicant: MEIJI CO., LTD., Tokyo (JP)

(72) Inventors: Kazuhiro MUKAIYAMA, Tokyo (JP); Kaoru HIGAKI, Tokyo (JP)

(73) Assignee: MEIJI CO., LTD., Tokyo (JP)

(21) Appl. No.: 17/614,793

(22) PCT Filed: Jun. 1, 2020
(86) PCT No.: PCT/JP2020/021522

§ 371 Date: Nov. 29, 2021

(30) Foreign Application Priority Data
May 31, 2019 (JP) 2019-102641

(51) Int. Cl. A23G 1/46; A23G 1/44; A23G 1/40

(52) U.S. Cl. CPC A23G 1/46; A23V 2002/00; A23G 1/40; A23G 1/44

(57) ABSTRACT

The invention provides a method for manufacturing oily confectionery, including a step of stirring an oily confectionery base containing 10% by mass or more or a milk protein or 20% by mass or more of a nonfat milk solid content for 1 hour or more with a temperature held at 50° C. or more and 60° C. or less.

### TECHNICAL FIELD

The invention relates to oily confectionery and a method for manufacturing the same.

### BACKGROUND ART

Patent Literatures 1 to 3 disclose chocolates having a relatively large protein or nonfat milk solid content.

Patent Literature 4 discloses a technique for crystalizing lactose to be blended in a chocolate base.

### PRIOR ART DOCUMENT

### Patent Literature

[Patent Literature 1] JP-A-S57-033547
[Patent Literature 2] JP-A-S61-173745
[Patent Literature 3] WO 2011/125644
[Patent Literature 4] U.S. Pat. No. 6,548,099

### SUMMARY OF INVENTION

There is, however, room for improvement in the conventional techniques including those described in Patent Literatures 1 to 4 from the viewpoints of inhibiting viscosity increase occurring in storage (particularly, static storage) of an oily confectionery base containing 10% by mass or more of a milk protein or 20% by mass or more of a nonfat milk solid content, and obtaining a better flavor of oily confectionery.

Therefore, an object of the invention is to provide a method for manufacturing oily confectionery by which viscosity increase occurring in storage (particularly, static storage) of an oily confectionery base containing 10% by mass or more of a milk protein or 20% by mass or more of a nonfat milk solid content is inhibited, and a flavor of oily confectionery obtained from the oily confectionery base is made better.

According to the invention, a method for manufacturing oily confectionery and the like described below can be provided.

1. A method for manufacturing oily confectionery, including a step of stirring an oily confectionery base containing 10% by mass or more of a milk protein or 20% by mess or more of a nonfat milk solid content for 1 hour or more with a temperature held at 50° C. or more and 60° C. or less.

2. The method for manufacturing oily confectionery according to 1, in which the milk protein is not subjected to an enzymatic treatment.

3. The method for manufacturing oily confectionery according to 1 or 2, in which the oily confectionery base contains 3% by mass or more of amorphous lactose.

4. The method for manufacturing oily confectionery according to any one of 1 to 3, in which the oily confectionery base contains 10% by mass or more of amorphous lactose.

5. The method for manufacturing oily confectionery according to any one of 1 to 4, in which the oily confectionery base contains 14% by mass or more of the milk protein.

6. The method for manufacturing oily confectionery according to any one of 1 to 5, in which the oily confectionery base contains 24% by mass or more of the nonfat milk solid content.

7. The method for manufacturing oily confectionery according to any one of 1 to 6, in which the oily confectionery base is stirred for 1 hour or more with the temperature held at 50° C. or more and 55° C. or less in the step.

8. The method for manufacturing oily confectionery according to any one of 1 to 7, in which the oily confectionery base in an amount of 3.2 t to 4.0 t is stirred in one bath for 1 hour or more with the temperature held at 50° C. or more and 60° C. or less.

9. The method for manufacturing oily confectionery according to any one of 1 to 8, in which the oily confectionery base is a chocolate base.

10. The method for manufacturing oily confectionery according to any one of 1 to 9, in which the oily confectionery base has been precedently subjected to a refining step.

11. Oily confectionery, manufactured by the method for manufacturing oily confectionery according to any one of 1 to 10.

12. The oily confectionery according to 11, having a viscosity after standing still at 50° C. for 24 hours of 49000 mPa·s or less.

13. The oily confectionery according to 11 or 12, in which increase of a viscosity after standing still at 50° C. for 24 hours is 20000 mPa·s or less.

14. The oily confectionery according to any one of 11 to 13, having a yield value after standing still at 50° C. for 24 hours of 20.0 Pa or less.

15. The oily confectionery according to any one of 11 to 14, in which increase of a yield value after standing still at 50° C. for 24 hours is 10.0 Pa or less.

16. Oily confectionery, containing 10% by mass or more of a milk protein or 20% by mass or more of a nonfat milk solid content, and having a viscosity after standing still at 50° C. for 24 hours of 49000 mPa·s or less.

17. Oily confectionery, containing 10% by mass or more of a milk protein or 20% by mass or more of a nonfat milk solid content, in which increase of a viscosity after standing still at 50° C. for 24 hours is 20000 mPa·s or less.

18. Oily confectionery, containing 10% by mass or more of a milk protein or 20% by mass or more of a nonfat milk solid content, and having a yield value after standing still at 50° C. for 24 hours of 20.0 Pa or less.

19. Oily confectionery, containing 10% by mass or more of a milk protein or 20% by mass or more of a nonfat milk solid content, in which increase of a yield value after standing still at 50° C. for 24 hours is 10.0 Pa or less.

20. The oily confectionery according to any one of 16 to 19, in which the milk protein is not subjected to an enzymatic treatment.

21. The oily confectionery according to any one of 16 to 20, containing 14% by mass or more of the milk protein.

22. The oily confectionery according to any one of 16 to 21, containing 24% by mass or more of the nonfat milk solid content.

23. The oily confectionery according to any one of 16 to 22, being a chocolate.

24. A method for inhibiting viscosity increase and/or poor meltability occurring in remelting an oily confectionery base containing 10% by mass or more of a milk protein or 20% by mass or more of a nonfat milk solid content, including: a step of stirring the oily confectionery base for 1 hour or more with a temperature held at 50° C. or more and 60° C. or less.

According to the invention, a method for manufacturing oily confectionery by which viscosity increase occurring in storage (particularly, static storage) of an oily confectionery base containing 10% by mass or more of a milk protein or 20% by mass or more of a nonfat milk solid content is inhibited, and a flavor of oily confectionery obtained from the oily confectionery base is made better can be provided.

### BRIEF DESCRIPTION OF DRAWINGS

FIG. 1 is a diagram illustrating a molten state of a chocolate base.

FIG. 2 is a diagram illustrating a result of X-ray crystal diffraction of a chocolate base.

FIG. 3 is a diagram illustrating a result of Raman imaging of a chocolate base.

FIG. 4 is a diagram illustrating a result of form observation of a chocolate base with a confocal laser microscope (CLSM).

### DESCRIPTION OF EMBODIMENTS

[Method for Manufacturing Oily Confectionery]

A method for manufacturing oily confectionery according to one embodiment of the invention includes a step of stirring an oily confectionery base containing 10% by mass or more of a milk protein or 20% by mass or more of a nonfat milk solid content for 1 hour or more with a temperature held at 50° C. or more and 60° C. or less (hereinafter, also referred to as the “heat-holding stirring step”). Thus, an effect of inhibiting viscosity increase otherwise occurring in storage (particularly, static storage) of the oily confectionery base and obtaining a better flavor of oily confectionery obtained from the oily confectionery base can be obtained.

As an example of oily confectionery, a conventional general milk chocolate contains a milk protein derived from powdered milk, but a milk protein content in the chocolate is not high, and hence, the chocolate should be ingested in a large amount for actively ingesting a milk protein. On the contrary, oily confectionery such as a milk chocolate manufactured in the present embodiment has a high milk protein content, and hence a milk protein can be efficiently ingested.

In general, a chocolate having a high protein content tends to be poorly melted in the mouth, but the oily confectionery such as a chocolate manufactured in the present embodiment is well melted in the mouth and has an excellent flavor.

A chocolate base having a high milk solid content including a milk protein has problems of viscosity increase caused when stored in a molten state and meltability obtained when the chocolate base is remelted after being solidified (for example, the remelted chocolate base becomes dumpy or highly viscous), and these problems can be solved by the present embodiment. According to the present embodiment, even when a chocolate base in a paste state is statically stored at 40° C. for 1 month or more, the viscosity increase and the poor meltability in remelting (formation of clumps and viscosity increase) are inhibited.

With respect to conventional techniques, the technique of Patent Literature 1 has the following problems. Since a milk protein should be subjected to an enzymatic treatment (protease treatment), a step of examining, for the manufacture, enzymatic treatment conditions suitable for obtaining a good milk protein is necessary, if a commercially available enzymatically treated milk protein is purchased, cost is increased.

In the technique of Patent Literature 2, a chocolate base having a milk protein added thereto is heated at 80° C. or more, a cooked odor derived from the milk protein is caused, and hence the flavor is probably easily impaired.

In the technique of Patent Literature 3, although it is stated that viscosity change of a chocolate in a molten state is inhibited, the content of a milk protein is limited.

In the technique of Patent Literature 4, since a crystallized milk powder obtained by subjecting powdered milk to a specific treatment should be used, versatility of a milk raw material is low, and in addition, it is difficult to inhibit viscosity increase of a chocolate base containing a large amount of amorphous lactose.

(Oily Confectionery Base)

Herein, “oily confectionery” may be a chocolate and a quasi-chocolate prescribed in “Fair Competition Code Concerning Labeling for Chocolates”, a rule certified by Japan Fair Trade Commission, and a fat cream and a nut paste not belonging to these. Alternatively, “oily confectionery” may be a white chocolate or white chocolate-like confectionery. The white chocolate-like confectionery refers to one obtained by replacing a part of cocoa butter of a white chocolate with another vegetable oil or fat excluding cocoa butter, and means oily confectionery containing 20 to 45% by mass of a vegetable oil or fat and 10 to 40% by mass of sugars.

The oily confectionery may be one manufactured by a conventionally known method. A nonfat milk solid content in the oily confectionery is not particularly limited, and may be, for example, 15 to 50% by mass, 20 to 45% by mass, or 23 to 41% by mass. An oil content in the oily confectionery is not particularly limited, and may be, for example, 30 to 50% by mass, 32 to 48% by mass or 35 to 45% by mass. A moisture content in the oily confectionery is not particularly limited, and may be, for example, 0 to 5% by mass, 0.3 to 3% by mass or 0.5 to 2% by mass.

The viscosity of the oily confectionery base is not particularly limited, and a viscosity measured with a B type viscometer at a temperature of the base of 40° C. with a rotor No. 6 at 4 rpm may be, for example, 20000 to 60000 mPa·s, 25000 to 55000 mPa·s or 30000 to 50000 mPa·s before adjustment with an emulsifier. If the oily confectionery base is aerated oily confectionery having a specific gravity less than 0.9, the viscosity is defined as a viscosity measured in a sample obtained by degassing the aerated oily confectionery by a known method to obtain a specific viscosity of 0.9.

The oily confectionery base is preferably a chocolate base.

(Milk Solid Content)

A milk solid content embraces a nonfat milk solid content and a milk fat content.

The oily confectionery base can contain, for example, 28% by mass or more, preferably 31% by mass or more, and more preferably 32% by mass or more of a milk solid content. The upper limit is not particularly limited, and is, for example, 40% by mass or less, and preferably 35% by mass or less,

(Nonfat Milk Solid Content)

The oily confectionery base can contain, for example, 15% by mass or more, 20% by mass or more, 21% by mass or more, preferably 23% by mass or more, more preferably 24% by mass or more and further preferably 25% by mass or more of a nonfat milk solid content. The upper limit is not particularly limited, and is, for example, 40% by mass or less, and preferably 30% by mass or less.

In general, when the content of the nonfat milk solid content in the oily confectionery base is high (for example, 15% by mass or more, and particularly 21% by mass or more), the following problem easily occurs. Even when porous food is to be impregnated with oily confectionery in production of impregnated food, the porous food cannot be impregnated to a portion close to the center thereof but is impregnated with only an oil or fat contained in the oily confectionery with an agglomerate attached to the surface thereof. On the contrary, such a problem can be improved by the present embodiment.

The nonfat milk solid content embraces a milk protein and lactose described below.

(Milk Protein)

A milk protein means a protein derived from milk.

A milk protein obtained by using, as a raw material, one of or a combination of two or more of commercially available milk ingredients such as a whole milk powder, a skim milk powder, a TMP (total milk protein), an MPC (milk protein concentrate) and a WPC (whey protein concentrate) can be used. Preferably, the raw material is any one of or a combination of two or more of a whole milk powder, a skim milk powder and a WPC.

Preferably, the milk protein is not subjected to an enzymatic treatment. When a milk protein not subjected to an enzymatic treatment is used, manufacture process can be simplified and manufacture cost can be reduced. According to the present embodiment, even when a milk protein not subjected to an enzymatic treatment is used, the effect of inhibiting the viscosity increase otherwise occurring in storage (particularly, static storage) of the oily confectionery base can be obtained.

As the milk protein, a milk protein subjected to an enzymatic treatment as described in Patent Literature 1, or a fractionated protein can be used, but in such a case, a milk protein not subjected to an enzymatic treatment is preferably used together. 10% by mass or more, 20% by mass or more, 30% by mass or more, 40% by mass or more, 50% by mass or more, 60% by mass or more, 70% by mass or more, 80% by mass or more, 90% by mass or more, 95% by mass or more, or 98% by mass or more of the whole milk protein contained in the chocolate base may be a milk protein not subjected to an enzymatic treatment.

The amount of the milk protein contained in a milk ingredient is not particularly limited, and is preferably 10% by mass or more, and more preferably 20% by mass or more.

The oily confectionery (base) can contain, for example, 5% by mass or more, 7% by mass or more, 8% by mass or more, 10% by mass or more, 12% by mass or more, or 14% by mass or more of the milk protein. The upper limit is not particularly limited, and can be, for example, 40% by mass or less, 35% by mass or less, or 30% by mass or less.

Besides, in the oily confectionery (base), a proportion of the milk protein in the nonfat milk solid content is not particularly limited, and a proportion of the milk protein calculated on the assumption that the amount of the nonfat milk solid content is 100% by mass can be, for example, 5% by mass or more, 10% by mass or more, 20% by mass or more, 30% by mass or more, or 35% by mass or more, and can be 98% by mass or less, 95% by mass or less, 93% by mass or less, or 90% by mass or less.

(Lactose)

Lactose embraces crystallized lactose and amorphous lactose.

In general, when a content of amorphous lactose in an oily confectionery base is high (for example, 70% by mass or more, 80% by mass or more, or 85% by mass or more of whole lactose contained in the oily confectionery base), the viscosity of the oily confectionery base is easily increased during storage in a molten paste state. Besides, when the oily confectionery base is solidified and then remelted, poor meltability such as formation of dumps and viscosity increase easily occurs. It is apprehended that such an oily confectionery base may “clog” a pipe in a manufacturing apparatus to greatly deteriorate manufacturing efficiency. Furthermore, poor meltability occurs when the oily confectionery base is remelted for use in manufacture after being solidified for storage or transport, and hence it is apprehended that the manufacturing efficiency may be lowered to deteriorate the quality of a resultant product.

In the oily confectionery base obtained in the present embodiment, the content of amorphous lactose derived from a raw material is reduced during manufacture process of the oily confectionery base, and therefore, the viscosity increase of the ultimately obtained oily confectionery base is inhibited.

Crystallization of amorphous lactose can be evaluated by X-ray diffraction, Raman imaging or the like.

The oily confectionery base may contain 1% by mass or more, 3% by mass or more, 5% by mass or more, 7% by mass or more, or 10% by mass or more of amorphous lactose. The upper limit is not particularly limited, and can be, for example, 30% by mass or less, 25% by mass or less, 20% by mass or less, or 15% by mass or less.

(Heat-Holding Stirring Step)

In the heat-holding stirring step, the oily confectionery base is stirred for 1 hour or more with the temperature held at 50° C. or more and 60° C. or less. While being stirred, the oily confectionery base can be in a paste form. The temperature of the oily confectionery base under stirring may be held at 50° C. or more and 58° C. or less, 50° C. or more and 55° C. or less, or 53° C. The stirring time may be 1 hour and 30 minutes or more, 2 hours or more, 3 hours or more, or 4 hours or more. The upper limit is not particularly limited, and can be, for example, 50 hours or less, 30 hours or less, 20 hours or less, or 10 hours or less.

In performing the present embodiment in a large scale facility, the effect of the invention is sufficiently exhibited by stirring 3.2 t to 4.0 t of the oily confectionery base in one bath for 1 hour or more with the temperature held at 50° C. or more and 60° C. or less, and when heat-holding and stirring is performed for 2 hours or more, and further for 3 hours or more, the effect of the invention is more satisfactorily exhibited.

In the heat-holding stirring step, a constant temperature bath equipped with a stirring function can be used, and it is preferable that the whole oily confectionery base is homogeneously stirred while being heated at a constant temperature.

The heat-holding stirring step may be performed by a batch method or a continuous method. When the continuous method is employed, an average retention time of the oily confectionery base in a continuous constant temperature bath in which the oily confectionery base is stirred with the temperature held at 50° C. or more and less than 60° C. may be set to 1 hour or more.

If the oily confectionery base is subjected to a refining step for reducing a particle size of particles contained in the oily confectionery base, the heat-holding stirring step may be performed before the refining step or after the refining step, and is preferably performed after the refining step. When the oily confectionery base is, for example, a chocolate base or the like, coarse particles of solid contents excluding a fat content, such as a cacao mass, a cocoa powder, a sugar and powdered milk, can be refined in the refining step to reduce the particle size measured with a micrometer, for example, to a particle size of about 10 μm to 35 μm. A refining apparatus used in the refining step is not particularly limited, and for example, a refining apparatus such as a roll mill or a ball mill can be used.

Besides, if the oily confectionery base is, for example, a chocolate base or the like, a conching step may be provided subsequently to the refining step. The heat-holding stirring step may be performed before the conching step or after the conching step, and is preferably performed after the conching step.

[Oily Confectionery]

Oily confectionery according to one embodiment of the invention is manufactured by the method for manufacturing oily confectionery described above.

The oily confectionery has a viscosity after standing still at 50° C. for 24 hours of preferably 49000 mPa·s or less. It is noted that the term “after standing still at 50° C. for 24 hours” refers to “after standing still at 50° for 24 hours immediately after manufacture or immediately after being melted at 50° C.”. This also applies to the following description.

In the oily confectionery, increase of the viscosity after standing still at 50° C. for 24 hours can be 20000 mPa·s or less, 15000 mPa·s or less, 10000 mPa·s or less, 5000 mPa·s or less, 3500 mPa·s or less, 3300 mPa·s or less, 3000 mPa·s or less, 2800 mPa·s or less, or 2500 mPa·s or less, and is preferably 3500 mPa·s or less.

In the oily confectionery, a yield value after standing still at 50° C. for 24 hours can be 20.0 Pa or less, 16.0 Pa or less, 13.0 Pa or less, 10.0 Pa or less, 8.0 Pa or less, 7.5 Pa or less, 7.0 Pa or less, 6.5 Pa or less, or 6.0 Pa or less, and is preferably 8.0 Pa or less.

In the oily confectionery, increase of the yield value after standing still at 50° C. for 24 hours can be 10.0 Pa or less, 8.0 Pa or less, 8.0 Pa or less, 4.0 Pa or less, 3.0 Pa or less, 2.8 Pa or less, 2.5 Pa or less, 2.3 Pa or less, or 2.0 Pa or less, and is preferably 3.0 Pa or less.

The oily confectionery according to one embodiment of the invention contains 10% by mass or more of a milk protein or 20% by mass or more of a nonfat milk solid content, and has a viscosity after standing still at 50° C. for 24 hours of 49000 mPa·s or less.

The oily confectionery according to one embodiment of the invention contains 10% by mass or more of a milk protein or 20% by mass or more of a nonfat milk solid content, and has increase of a viscosity after standing still at 50° C. for 24 hours of 20000 mPa·s or less, 15000 mPa·s or less, 10000 mPa·s or less, 5000 mPa·s or less, 3500 mPa·s or less, 3300 mPa·s or less, 3000 mPa·s or less, 2800 mPa·s or less, or 2500 mPa·s or less, and preferably 3500 mPa·s or less.

The oily confectionery according to one embodiment of the invention contains 10% by mass or more of a milk protein or 20% by mass or more of a nonfat milk solid content, and has a yield value after standing still at 50° C. for 24 hours of 20.0 Pa or less, 16.0 Pa or less, 13.0 Pa or less, 10.0 Pa or less, 8.0 Pa or less, 7.5 Pa or less, 7.0 Pa or less, 8.5 Pa or less, or 6.0 Pa or less, and preferably 8.0 Pa or less.

The oily confectionery according to one embodiment of the invention contains 10% by mass or more of a milk protein or 20% by mass or more of a nonfat milk solid content, and has increase of a yield value after standing still at 50° C. for 24 hours of 10.0 Pa or less, 8.0 Pa or less, 6.0 Pa or less, 4.0 Pa or less, 3.0 Pa or less, 2.8 Pa or less, 2.5 Pa or less, 2.3 Pa or less, or 2.0 Pa or less, and preferably 3.0 Pa or less.

With respect to the oily confectionery, the description given above on the method for manufacturing oily confectionery is appropriately incorporated. With respect to the composition of the oily confectionery, the description given above on the composition of the oily confectionery base excluding the ratio between crystallized lactose and amorphous lactose constituting lactose is appropriately incorporated.

The oily confectionery contains, in an oily confectionery base before being subjected to the heat-holding stirring step, preferably 3% by mass or more, and more preferably 10% by mass or more of amorphous lactose.

[Method for Inhibiting Viscosity Increase of Oily Confectionery Base and/or Poor Meltability Occurring in Remelting]

A method for inhibiting viscosity increase of an oily confectionery base and/or poor meltability occurring in remelting according to one embodiment of the invention includes a step of stirring an oily confectionery base containing 10% by mass or more of a milk protein or 20% by mass or more of a nonfat milk solid content for 1 hour or more with a temperature held at 50° C. or more and 60° C. or less. With respect to this method, the description given above on the method for manufacturing oily confectionery is incorporated.

[Impregnated Food and Method for Manufacturing the Same]

Impregnated food according to one embodiment of the invention contains porous solid food, and oily confectionery containing 10% by mass or more of a milk protein or 20% by mass or more of a nonfat milk solid content, with the porous solid food impregnated with the oily confectionery.

The porous solid food may be any food having porous voids therein, may be, for example, baked confectionery, and more specifically, may be a cookie, a biscuit, a corn puff, a sponge cake, a crouton or the like. The size of voids in the porous solid food may be, for example, 50 to 1500 μm, 100 to 1000 μm, or 200 to 700 μm. The porosity of the porous solid food may be, for example, 50 to 98%, 6 to 95%, or 70 to 90%.

A more remarkable effect can be attained under conditions where impregnation is difficult to be performed by a conventional technique, that is, in a case where the content of a milk protein in the oily confectionery is 10% by mass or more and/or the content of a nonfat milk solid content in the oily confectionery is 20% by mass or more, and/or the oil content in the oily confectionery is 46% by mass or less, and/or a median diameter of a particle of a solid content in an oily confectionery base is larger than 6 μm.

In the present embodiment, as a method for impregnating the porous solid food with the oily confectionery base, a decompression method or a compression method is employed.

As the oily confectionery base, an oily confectionery base obtained by the above-described method for manufacturing an oily confectionery base (an oily confectionery base resulting from the heat-holding stirring step) can be used.

The oily confectionery base may be caused to stand still before impregnating the porous solid food with the oily confectionery base. This step is not always necessary, but the impregnation can be more satisfactorily performed when it is caused to stand still. A temperature at which the base is caused to stand still is preferably 40 to 60° C.

In the impregnation, the porous solid food is first buried in an oily confectionery base bath. At this point, it is preferable that the porous solid food is not exposed from the oily confectionery base bath. This is for sufficiently permeating the oily confectionery base into the porous solid food because if a part of the porous solid food is not covered with the oily confectionery base, the air is priority restored into the porous solid food in the impregnating step. Then, the oily confectionery base bath in which the porous solid food is buried is put in a decompression chamber, and the chamber is sealed.

Next, a pressure within the chamber is lowered to degas the porous solid food. The pressure within the chamber may be lowered to, for example, 0.008 to 0.090 MPa, or may be lowered to 0.01 to 0.05 MPa. Besides, a time for lowering the pressure within the chamber may be, for example, 1 second to 120 seconds, or 10 seconds to 60 seconds.

Next, the pressure within the chamber is increased up to the atmospheric pressure to permeate the oily confectionery base into the porous solid food. If necessary, the pressure within the chamber may be increased beyond the atmospheric pressure. The pressure may be increased, for example, to a pressure beyond the atmospheric pressure and 0.6 MPa or less.

In one embodiment of the invention, the method for impregnating a porous solid food with an oily confectionery base includes impregnating the porous solid food with an oily confectionery base under the “conditions where impregnation is difficult to be performed”, for example, an oily confectionery base containing a milk protein in an amount of 10% by mass or more, or a nonfat milk solid content in an amount of 20% by mass or more after a step (heat-holding stirring step) of stirring the oily confectionery base for 1 hour or more with the temperature held at 50° C. or more and 60° C. or less. In this manner, impregnated food in which porous solid food is impregnated, into the inside thereof, with an oily confectionery base under the “conditions where impregnation is difficult to be performed” can be manufactured. Besides, components of the oily confectionery base can be prevented from separating during the impregnation process. In the present embodiment, when the step of causing the oily confectionery base to stand still is to be provided, it is preferably provided after the heat-holding stirring step.

### EXAMPLES

Now, the invention will be more specifically described with reference to examples, and it is noted that the scope of the invention is not limited by the description of these examples.

### 1. Preparation of Chocolate Having High Milk Protein Content

### Example 1

<Manufacture of Chocolate>

Raw materials shown in Table 1 were provided and mixed by an ordinary method in accordance with Composition 1 shown in Table 1, and the resultant mixture was roll milled and subjected to conching to prepare a chocolate base (which chocolate base in this state is designated as the “chocolate base A”). The chocolate base A in a paste state was stirred for 1 hour with the temperature held at 50 to 55° C. (target temperature: 53° C.) (which chocolate base obtained after stirring is designated as the “chocolate base B”). The chocolate base B was filled in a mold, and the resultant was solidified by cooling to obtain a chocolate.

Amounts in each composition shown in Table 1 are in percentage by mass.

TABLE 1

| | Compo- | Compo- | Compo- | Compo- |
|---|---|---|---|---|
| | sition 1 | sition 2 | sition 3 | sition 4 |
| Sugar | 20 | 15 | 25 | 14 |
| Whole Milk Powder | 20 | 0 | 0 | 0 |
| Cacao Mass | 15 | 25 | 0 | 0 |
| Oil and Fat (including cocoa | 26 | 24 | 44 | 40 |
| butter and vegetable oils and | | | | |
| fats, etc.) | | | | |
| Whey Protein | 10 | 35 | 30 | 45 |
| Skim Milk Powder | 8 | 0 | 0 | 0 |
| Others (including emulsifier | 1 | 1 | 1 | 1 |
| and flavor, etc.) | | | | |
| Total | 100 | 100 | 100 | 100 |
| Mixing Rate of Milk Protein | 16 | 27 | 24 | 35 |
| Mixing Rate of Milk Solid | 36 | 33 | 28 | 42 |
| Content | | | | |
| Mixing Rate of Nonfat Milk | 30 | 31 | 27 | 40 |
| Solid Content | | | | |
| Mixing Rate of Amorphous | 13 | 4 | 3 | 5 |
| Lactose | | | | |

<Static Storage Test>

About 250 g of the chocolate base B was enclosed in a beaker and the resultant was statically stored in an incubator at 50° C. for 1 day (24 hours) (which chocolate base after the storage is designated as the “chocolate base C”).

<Viscosity Measurement>

250 g each of the chocolate bases B and C was weighed, and adjusted to a temperature of 40° C., and the viscosity was measured. The viscosity measurement was performed under the following conditions:

Viscometer: BH type viscometer

Rotor: No. 6

Rotational Speed: 4 rpm

Measurement Temperature: 40° C.

<Sensory Evaluation>

A flavor of the chocolate base B was evaluated in accordance with the following criteria. The evaluation was performed by a panel of seven chocolate experts having been sufficiently trained to be able to give the same score to the same sample. A score was determined through conference among the experts.

A: particularly preferable

B: preferable

C: rather unpreferable

D: unpreferable

<Comprehensive Evaluation>

Comprehensive evaluation was made in accordance with the following criteria based on not only the result of the sensory evaluation but also handleability in molding the chocolate base B obtained after heat-holding and stirring and the chocolate base C obtained after static storage.

A: particularly preferable

B: preferable

C: rather unpreferable

D: unpreferable

### Example 2

A chocolate was prepared and a static storage test was performed in the same manner as in Example 1 except that the stirring was performed for 2 hours with the chocolate temperature held at 50 to 55° C. (target temperature: 53° C.).

### Example 3

A chocolate was prepared and a static storage test was performed in the same manner as in Example 1 except that the stirring was performed for 1 hour with the chocolate temperature held at 60° C.

### Example 4

A chocolate was prepared and a static storage test was performed in the same manner as in Example 1 except that Composition 2 was employed instead of Composition 1.

### Example 5

A chocolate was prepared and a static storage test was performed in the same manner as in Example 4 except that the stirring was performed for 2 hours with the chocolate temperature held at 50 to 55° C. (target temperature: 53° C.).

### Example 6

A chocolate was prepared and a static storage test was performed in the same manner as in Example 4 except that the stirring was performed for 1 hour with the chocolate temperature held at 60° C.

### Example 7

A chocolate was prepared and a static storage test was performed in the same manner as in Example 1 except that Composition 3 was employed instead of Composition 1.

### Example 8

A chocolate was prepared and a static storage test was performed in the same manner as in Example 7 except that the stirring was performed for 2 hours with the chocolate temperature held at 50 to 55° C. (target temperature: 53° C.).

### Example 9

A chocolate was prepared and a static storage test was performed in the same manner as in Example 7 except that the stirring was performed for 1 hour with the chocolate temperature held at 60° C.

### Example 10

A chocolate was prepared and a static storage test was performed in the same manner as in Example 1 except that Composition 4 was employed instead of Composition 1.

### Example 11

A chocolate was prepared and a static storage test was performed in the same manner as in Example 10 except that the stirring was performed for 2 hours with the chocolate temperature held at 50 to 55° C. (target temperature: 53° C.).

### Example 12

A chocolate was prepared and a static storage test was performed in the same manner as in Example 10 except that the stirring was performed for 1 hour with the chocolate temperature held at 60° C.

### Comparative Example 1

A chocolate was prepared and a static storage test was performed in the same manner as in Example 1 except that the stirring was performed for 1 hour with the chocolate temperature held at 45° C.

### Comparative Example 2

A chocolate was prepared and a static storage test was performed in the same manner as in Example 4 except that the stirring was performed for 1 hour with the chocolate temperature held at 45° C.

### Comparative Example 3

A chocolate was prepared and a static storage test was performed in the same manner as in Example 7 except that the stirring was performed for 1 hour with the chocolate temperature held at 45° C.

### Comparative Example 4

A chocolate was prepared and a static storage test was performed in the same manner as in Example 10 except that the stirring was performed for 1 hour with the chocolate temperature held at 45° C.

Results thus obtained are shown in Table 2.

TABLE 2

| | Chocolate Viscosity | | | | |
|---|---|---|---|---|---|
| | (mPa · s) | | Viscosity | | Comprehensive |
| | Before Storage | After Storage | Increase Rate | Sensory Evaluation | Evaluation |
| Example 1 | 26,250 | 45,000 | 1.7 | B | B |
| Example 2 | 26,250 | 26,250 | 1.0 | A | A |
| Example 3 | 26,250 | 26,250 | 1.0 | C | B |
| | | | | (protein odor rather felt) | |
| Example 4 | 23,750 | 42,500 | 1.8 | B | B |
| Example 5 | 23,750 | 25,000 | 1.1 | A | A |
| Example 6 | 23,750 | 25,000 | 1.1 | C | B |
| | | | | (protein odor rather felt) | |
| Example 7 | 27,500 | 40,000 | 1.5 | B | B |
| Example 8 | 27,500 | 27,500 | 1.0 | A | A |
| Example 9 | 27,500 | 25,000 | 0.9 | C | B |
| | | | | (protein odor rather felt) | |
| Example 10 | 25,000 | 37,000 | 1.5 | B | B |
| Example 11 | 25,000 | 26,250 | 1.1 | A | A |
| Example 12 | 25,000 | 22,500 | 0.9 | C | B |
| | | | | (too strongly sticky in mouth) | |
| Comparative | 26,250 | 120,000 | 4.6 | D | D |
| Example 1 | | | | (too strongly sticky in mouth) | |
| Comparative | 23,750 | 50,000 | 2.1 | D | D |
| Example 2 | | | | (too strongly sticky in mouth) | |
| Comparative | 27,500 | 52,500 | 1.9 | D | D |
| Example 3 | | | | (too strongly sticky in mouth) | |
| Comparative | 25,000 | 57,500 | 2.3 | D | D |
| Example 4 | | | | (too strongly sticky in mouth) | |

*Viscosity increase rate = viscosity after storage/viscosity before storage

<Evaluation>

When a chocolate base containing 14 to 36% by mass of a milk protein was stirred for 1 hour or more with the temperature held at 50 to 60° C., a chocolate base having a good flavor and a viscosity difficult to increase could be obtained (viscosity increase rate: 1.7 or less). When the stirring time was 2 hours, the flavor was better and the viscosity increase was further inhibited (viscosity increase rate: 1.1 or less) as compared with when the stirring time was 1 hour. Besides, the thus obtained chocolates had a good flavor and were well melted in the mouth.

The viscosity of the chocolate base had a lower value when the temperature in stirring was 60° C. than when the temperature was held at 50 to 55° C. All the chocolates obtained from the chocolate bases subjected to stirring at 60° C. for 1 hour rather had, however, a protein odor.

Besides, the chocolates obtained from the chocolate bases subjected to stirring at 40° C. for 1 hour are not preferable because of too strong stickiness in the mouth.

### 2. Manufacture of Chocolate Having High Milk Protein Content (Scale of Factory Line: Facility for 4 t)

### Example 13

<Manufacture of Chocolate>

The raw materials of Composition 1 shown in Table 1 were provided and mixed by an ordinary method, and the resultant mixture was roll milled and subjected to conching to prepare a chocolate base A. The chocolate base A in a paste state was stirred for 5 hours and 40 minutes with the temperature held at 50 to 60° C. (target temperature: 53° C.) to obtain a chocolate base B.

<Static Storage Test and Sensory Evaluation>

About 250 g of the chocolate base B was enclosed in a beaker, and the resultant was statically stored in an incubator at 40° C. for 1 month, 2 months, or 3 months to obtain chocolate bases C (respectively of 1 month storage, 2 month storage and 3 month storage). Each chocolate base C was filled in a mold, and the resultant was solidified by cooling to obtain a chocolate. The chocolate was evaluated for the flavor in the same manner as in Example 1.

<Viscosity Measurement>

250 g each of the chocolate bases B and C was weighed, the temperature was adjusted to 40° C., and then the viscosity was measured. The viscosity measurement was performed under the following conditions:

Viscometer: BH type viscometer

Rotor: No. 6

Rotational Speed: 4 rpm

Measurement Temperature: 40° C.

Results thus obtained are shown in Table 3.

TABLE 3

| | | | | | Sensory |
|---|---|---|---|---|---|
| | | After | After | After | Evaluation |
| | Before | 1-Month | 2-Month | 3-Month | (after 3-month |
| | Storage | Storage | Storage | Storage | storage) |
| Chocolate | 16200 | 20000 | 18750 | 17500 | B |
| Viscosity | | | | | |
| (mPa · s) | | | | | |
| Viscosity | — | 1.2 | 1.2 | 1.1 | |
| Increase | | | | | |
| Rate | | | | | |

<Evaluation>

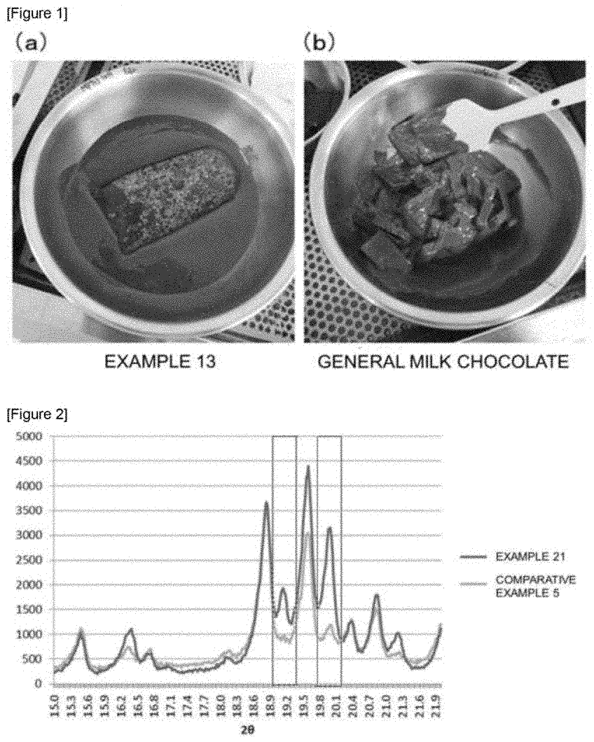

In the sensory evaluation, the chocolate base was not found to have an abnormal flavor or deteriorated taste even after the three month storage. Besides, as is understood from FIG. 1 illustrating a molten state of the chocolate base, the chocolate base of Example 13 did not have a problem of meltability even when stored for 3 months, then molded and remelted (FIG. 1(a)). Specifically, dumps were not formed in melting, and viscosity increase was also inhibited (viscosity increase rate: 1.2 or less). On the contrary, when a general milk chocolate (not subjected to heat-holding stirring) was remelted, dumps were formed (FIG. 1(b)).

### 3. Manufacture of Milk Chocolate Having High Milk Solid Content (Scale of Factory Line: Facility for 4 t)

### Example 14

<Manufacture of Chocolate>

Raw materials of Composition 5 shown in Table 4 were provided and mixed by an ordinary method, and the resultant mixture was roll milled and subjected to conching to prepare a chocolate base A. The chocolate base A in a paste state was stirred for 3 hours and 15 minutes with the temperature held at 50 to 60° C. (target temperature: 53° C.) to obtain a chocolate base B.

Amounts in the composition shown in Table 4 are in percentage by mass.

<Static Storage Test and Sensory Evaluation>

About 250 g of the chocolate base B was enclosed in a beaker, and the resultant was statically stored in an incubator at 40° C. for 2 weeks to obtain a chocolate base C. The chocolate base C was evaluated for the flavor in the same manner as in Example 1.

<Viscosity Measurement>

A viscosity was measured in the same manner as in Example 13.

TABLE 4

| | Composition 5 |
|---|---|
| Sugar | 35 |
| Whole Milk Powder | 25 |
| Cacao Mass | 15 |
| Oil and Fat | 20 |
| (including cocoa butter and vegetable oils and fats, etc.) | |
| Skim Milk Powder | 4 |
| Others (including emulsifier and flavor, etc.) | 1 |
| Total | 100 |
| Mixing Rate of Milk Protein | 8 |
| Mixing Rate of Milk Solid Content | 28 |
| Mixing Rate of Nonfat Milk Solid Content | 21 |
| Mixing Rate of Amorphous Lactose | 12 |

### Example 15

A chocolate was prepared in the same manner as in Example 14 except that the stirring was performed for 3 hours and 30 minutes with the chocolate temperature held at 50 to 60° C., and the resultant chocolate was subjected to a static storage test, sensory evaluation and viscosity measurement.

### Example 16

A chocolate was prepared in the same manner as in Example 14 except that the stirring was performed for 4 hours and 20 minutes with the chocolate temperature held at 50 to 60° C., and the resultant chocolate was subjected to a static storage test, sensory evaluation and viscosity measurement.

### Example 17

A chocolate was prepared in the same manner as in Example 14 except that the stirring was performed for 2 hours and 30 minutes with the chocolate temperature held at 50 to 60° C., and the resultant chocolate was subjected to a static storage test, sensory evaluation and viscosity measurement.

Results thus obtained are shown in Table 5.

TABLE 5

| | Chocolate Viscosity (mPa · s) | | |
|---|---|---|---|
| | Before | After 1-Week | After 2-Week |
| | Storage | Storage | Storage |
| Example 14 | 25000 | 42500 | 77500 |
| Example 15 | 27500 | 28750 | 51250 |
| Example 16 | 25000 | 36250 | 46250 |
| Example 17 | 25000 | 62500 | 142500 |

<Evaluation>

When a chocolate base containing 28% by mass of a milk solid content was stirred for 2 hours or more with the temperature held at 50 to 55° C., a chocolate base having a good flavor and inhibited in viscosity increase could be obtained. On an industrial manufacture scale, the viscosity increase was further inhibited when the stirring time was long (3 hours or more). A chocolate base having a viscosity, measured with a BH type viscometer and a rotor No. 6 at a rotational speed of 4 rpm and a measurement temperature of 40° C., of 100000 mPa·s or less could be transported through a pipe without hindrance and had a good flavor, but a chocolate base having a viscosity beyond this value was rather poorly melted in the mouth.

<Evaluation of Melting Property>

Chocolates were obtained by respectively solidifying, by cooling, the chocolate base B of Example 16 and a control chocolate base A (having the same composition as Example 16) prepared without stirring at 50 to 60° C. 50 g of each chocolate was put in a stainless steel bowl, and was stored in a constant temperature bath at 55° C. for 0 to 30 minutes. The state of the chocolate was observed 5, 10, 11, 12, 15, 20 and 30 minutes after starting the storage, and was visually evaluated as follows:

+++: The shape of the chocolate largely remains.

++: The shape remains.

+: The shape rather remains.

−: The chocolate has melted.

Results thus obtained are shown in Table 6.

TABLE 6

| Melting Time (min) | Control | Example 16 |
|---|---|---|
| 5 | + + + | + + |
| 10 | + + | + |
| 11 | + + | ◯ |
| 12 | + + | |
| 15 | + + | |
| 20 | + | |
| 30 | ◯ | |

In the chocolate manufactured by the method of the invention, a time elapsed until it had completely melted was remarkably reduced as compared with the untreated chocolate. When the chocolates solidified by cooling as described above were eaten, the chocolate manufactured by the method of the invention was excellently melted in the mouth as compared with the untreated chocolate.

### 4. Manufacture of Chocolate Having High Milk Solid Content (Scale of Factory Line: Facility for 4 t)

### Example 18

<Manufacture of Chocolate>

Raw materials of Composition 6 shown in Table 7 were provided and mixed by an ordinary method, and the resultant mixture was roll milled and subjected to conching to prepare a chocolate base A. The chocolate base A in a paste state was stirred for 3 hours and 30 minutes with the temperature held at 50 to 60° C. (target temperature: 53° C.) to obtain a chocolate base B.

Amounts in the composition shown in Table 7 are in percentage by mass.

TABLE 7

| | Composition 6 |
|---|---|
| Cacao Mass | 38 |
| Whole Milk Powder | 33 |
| Sugar | 21 |
| Oil and Fat | 7 |
| (Including cocoa butter and vegetable oils and fats, etc.) | |
| Others (including emulsifier and flavor, etc.) | 1 |
| Total | 100 |
| Mixing Rate of Milk Protein | 8 |
| Mixing Rate of Milk Solid Content | 31 |
| Mixing Rate of Nonfat Milk Solid Content | 23 |
| Mixing Rate of Amorphous Lactose | 13 |

<Static Storage Test and Sensory Evaluation>

About 250 g of the chocolate base B was enclosed in a beaker, and the resultant was statically stored in an incubator at 40° C. for 4 weeks to obtain a chocolate base C. The chocolate base C was evaluated for the flavor in the same manner as in Example 1.

<viscosity Measurement>

A viscosity was measured in the same manner as in Example 13.

### Example 19

A chocolate was prepared in the same manner as in Example 18 except that the stirring was performed for 1 hour and 40 minutes with the chocolate temperature held at 50 to 60° C., and the resultant chocolate was subjected to a static storage test, sensory evaluation and viscosity measurement.

### Example 20

A chocolate was prepared in the same manner as in Example 18 except that the stirring was performed for 4 hours with the chocolate temperature held at 40° C., and the resultant chocolate was subjected to a static storage test, sensory evaluation and viscosity measurement.

Results thus obtained are shown in Table 8.

TABLE 8

| | Chocolate Viscosity (mPa · s) | | | | |
|---|---|---|---|---|---|
| | | After | After | After | After |
| | Before | 1-Week | 2-Week | 3-Week | 4-Week |
| | Storage | Storage | Storage | Storage | Storage |
| Example 18 | 35000 | 38400 | 40900 | 49100 | 56800 |
| Example 19 | 31000 | 37900 | 42100 | 55900 | 73300 |
| Example 20 | 41700 | 53900 | 68200 | 106600 | 190100 |

<Evaluation>

When a chocolate base containing 31.3% by mass of a milk solid content was stirred for 1.5 hours or more with the temperature held at 50 to 55° C., a chocolate base having a good flavor and inhibited in viscosity increase could be obtained. On an industrial manufacture scale, as is understood from Example 18, a long stirring time (of 3 hours or more) is preferable because the viscosity increase is thus further inhibited. A chocolate base having a viscosity, measured with a BH type viscometer and a rotor No. 6 at a rotational speed of 4 rpm and a measurement temperature of 40° C., of 100000 mPa·s or less could be transported through a pipe without hindrance and had a good flavor, but a chocolate base having a viscosity beyond this value was rather poorly melted in the mouth.

<Evaluation of Melting Property>

Chocolates were obtained by respectively solidifying, by cooling, the chocolate base of Example 14 and a control chocolate base (having the same composition as Example 14) prepared without stirring at 50 to 60° C. 50 g of each chocolate was put in a stainless steel bowl, and was stored in a constant temperature bath at 55° C. for 0 to 30 minutes. The state of the chocolate was observed 5, 10, 11, 12, 15, 20 and 30 minutes after starting the storage, and was visually evaluated as follows:

+++: The shape of the chocolate largely remains.

++: The shape remains.

+: The shape rather remains.

−: The chocolate has melted.

Results thus obtained are shown in Table 9.

TABLE 9

| Melting Time (min) | Control | Example 14 |
|---|---|---|
| 5 | + + + | + + |
| 10 | + + | + |
| 11 | + + | ◯ |
| 12 | + | |
| 15 | ◯ | |

In the chocolate manufactured by the method of the invention, a time elapsed until it had completely melted was remarkably reduced as compared with the untreated chocolate.

### 5. Manufacture of Impregnated Food

### Production Example 1

A white chocolate base having a nonfat milk solid content of 23% by mass and an oil content of 41.0% by mass was obtained by mixing, by an ordinary method, 34.2 parts by mass of sugar, 30.2 parts by mass of a whole milk powder, 22 parts by mass of cocoa butter, 10.6 parts by mass of a vegetable oil or fat (trade name: Melano SS, manufactured by FUJI OIL CO., LTD.), 2.5 parts by mass of a skim milk powder, and 0.5 parts by mass of lecithin, and milling the resultant mixture with a refiner. With respect to a particle size of a solid content particle contained in the thus obtained white chocolate base, a median diameter measured with a micrometer (manufactured by Mitutoyo Corporation) was 15 to 20 μm.

### Production Example 2

A white chocolate base having a nonfat milk solid content of 41% by mass and an oil content of 45.1% by mass was obtained by mixing, by an ordinary method, 14.8 parts by mass of sugar, 29.7 parts by mass of a whole milk powder, 32.8 parts by mass of cocoa butter, 21.5 parts by mass of a skim milk powder, 0.7 parts by mass of lecithin, and 0.5 parts by mass of an emulsifier (trade name: DK Ester F90, manufactured by DKS Co., Ltd.), milling the resultant mixture with a refiner, and subjecting the resultant to conching. A median diameter of solid content particles contained in the thus obtained white chocolate base measured with a micrometer (manufactured by Mitutoyo Corporation) was 15 to 20 μm.

### Production Example 3

A batter, which was obtained by mixing, by an ordinary method under stirring, 24.6 parts by mass of a chicken egg, 34.7 parts by mass of a fluor, 22.3 parts by mass of sugar, 12.3 parts by mass of a vegetable oil or fat, 2.2 parts by mass of lecithin, 2.1 parts by mass of a skim milk powder and 1.8 parts by mass of water, was formed into a substantially elliptic shape, and the resultant was baked in an oven at 190° C. for 9 minutes, and dried at 100° C. for 15 minutes to obtain a porous biscuit. The mass of each biscuit thus obtained was 0.85 g, the porosity was 85.6%, and an average void diameter of voids contained in the biscuit was 300 μm.

### Example 21

300 parts by mass of the chocolate base obtained in Production Example 1 was stirred for 5 hours with the temperature held at 50° C., the resultant was caused to stand still at 50° C. for 2 weeks, and then the temperature of the resultant was adjusted to 30° C. At this point, the chocolate base had a viscosity of 30000 mPa·s. To 300 parts by mass of the chocolate base, 2.7 parts by mass of an emulsifier (trade name: PGPR4150, manufactured by DKSH Japan K.K.) was added, followed by mixing with stirring. The resultant chocolate base had a viscosity of 7500 mPa·s.

To the thus obtained chocolate base, 0.9 parts by mass of a seed agent (trade name: Chocoseed A, manufactured by FUJI OIL CO., LTD.) was added, followed by mixing with stirring, and thus, a chocolate base for impregnation was obtained.

In a 300 mL beaker, 3.4 g of the biscuit obtained in Production Example 3 was put, and the resultant beaker was filled with the chocolate base for impregnation.

The resultant beaker was put in a chamber for decompression, and a pressure within the decompression chamber was reduced to 0.0092 MPa, and was retained at that pressure for 1 second. Thereafter, the decompression was gradually released, and thus, the pressure within the chamber was restored to the atmospheric pressure in 5 seconds.

The biscuit was taken out of the beaker, an excessive portion of the chocolate base remaining on the surface was removed, and the resultant was solidified by cooling to obtain impregnated chocolate confectionery. The mass of the thus obtained impregnated chocolate confectionery was 15.9 g.

When the obtained impregnated chocolate confectionery was observed, the chocolate was homogeneously permeated into the inside of the biscuit, and a degreased hard chocolate coating was not formed on the surface of the biscuit.

### Comparative Example 5

300 parts by mass of the chocolate base obtained in Production Example 1 was stirred for 5 hours with the temperature held at 45° C., the resultant was caused to stand still at 50° C. for 2 weeks, and then, the temperature of the resultant was adjusted to 30° C. At this point, the chocolate base had a viscosity of 110000 mPa·s. To 300 parts by mass of the chocolate base, 9 parts by mass of an emulsifier (trade name: PGPR4150, manufactured by DKSH Japan K.K.) was added, followed by mixing with stirring. The resultant chocolate base had a viscosity of 7500 mPa·s.

To the thus obtained chocolate, 0.9 parts by mass of a seed agent (trade name: Chocoseed A, manufactured by FUJI OIL CO., LTD.) was added, followed by mixing with stirring, and thus, a chocolate base for impregnation was obtained.

In a 300 ml beaker, 3.3 g of the biscuit obtained in Production Example 3 was put, and the resultant beaker was filled with the chocolate base for impregnation.

The beaker was put in a chamber for decompression, and a pressure within the decompression chamber was reduced to 0.0092 MPa and was retained at that pressure for 1 second. Thereafter, the decompression was gradually released, and thus, the pressure within the chamber was restored to the atmospheric pressure in 5 seconds.

The biscuit was taken out of the beaker, an excessive portion of the chocolate base remaining on the surface was removed, and the resultant was solidified by cooling to obtain impregnated chocolate confectionery. The mass of the thus obtained impregnated chocolate confectionery was 14.8 g.

The impregnated chocolate confectionery was obtained in the same manner as in Production Example 1 with the chocolate base temperature in stirring, the stirring time, the amount of an emulsifier to be added, and a chocolate to be used changed.

When the obtained impregnated chocolate confectionery was observed, the chocolate was not permeated into the inside of the biscuit, and a degreased hard chocolate coating was formed on the surface of the biscuit.

### Examples 22 to 26 and Comparative Examples 5 to 8

Impregnated chocolate confectionery was obtained in the same manner as in Example 21 with the chocolate temperature in stirring, the stirring time, the amount of an emulsifier to be added, and the composition of the chocolate changed as shown in Table 10.

In the impregnated chocolate confectionery using a chocolate obtained with the chocolate temperature in stirring set to 50° C. or more, the chocolate was homogeneously permeated into the inside of the biscuit, and a degreased hard chocolate coating was not formed on the surface of the biscuit. On the other hand, in the impregnated chocolate confectionery using a chocolate obtained with the chocolate temperature in stirring set to 45° C., the chocolate was not permeated into the inside of the biscuit, and a degreased hard chocolate coating was formed on the surface of the biscuit.

<Appearance>

The appearance of the impregnated chocolate confectionery was evaluated in accordance with the following criteria.

A: A chocolate coating is not formed.

B: Although a chocolate coating is not formed on the biscuit surface, the confectionery looks rather white.

C: A chocolate coating is formed on the biscuit surface.

<Comprehensive Evaluation>

The impregnated chocolate confectionery was evaluated in accordance with the following criteria based on a state of the chocolate permeation into the biscuit in the impregnated chocolate confectioner, a state on the surface of the biscuit and the like:

A: The quality is very preferable.

B: The quality is preferable.

C: The quality is not preferable.

D: The quality is very unpreferable.

Results thus obtained are shown in Table 10.

TABLE 10

| | | | | | | Chocolate Viscosity | | | | |
|---|---|---|---|---|---|---|---|---|---|---|
| | | | | | Emulsifier | (mPa · s) | | | Proportion of | |
| | | Temperature | Stirring | | Addition | Before | After | | Chocolate | Comprehensive |
| | Chocolate | in Stirring | Time | | Rate (*1) | Adjustment | Adjustment | Appearance | (mass %) | Evaluation |
| Example 21 | Production | 50° C. | 5 | hrs. | 0.9 | 30000 | 7500 | A | 78.7 | A |
| | Example 1 | | | | | | | | | |
| Example 22 | Production | 50° C. | 60 | min | 0.9 | 35000 | 7500 | A | 78.8 | A |
| | Example 1 | | | | | | | | | |
| Example 23 | Production | 50° C. | 40 | min | 0.9 | 37000 | 7500 | B | 78.8 | B |
| | Example 1 | | | | | | | | | |
| Example 24 | Production | 55° C. | 60 | min | 0.9 | 33750 | 7500 | A | 78.6 | A |
| | Example 1 | | | | | | | | | |
| Example 25 | Production | 60° C. | 60 | min | 0.9 | 33750 | 7500 | A | 79.1 | A |
| | Example 1 | | | | | | | | | |
| Example 26 | Production | 55° C. | 60 | min | 0.9 | 48750 | 10000 | A | 79.1 | A |
| | Example 2 | | | | | | | | | |
| Comparative | Production | 45° C. | 5 | hrs. | 3.0 | 110000 | 7500 | C | 81.2 | C |
| Example 5 | Example 1 | | | | | | | | | |
| Comparative | Production | 45° C. | 60 | min | 3.2 | 75000 | 7500 | C | 76.2 | C |
| Example 6 | Example 1 | | | | | | | | | |
| Comparative | Production | 45° C. | 40 | min | 3.2 | 86250 | 7500 | C | 76.2 | C |
| Example 7 | Example 1 | | | | | | | | | |
| Comparative | Production | 45° C. | 60 | min | 3.5 | 160000 | 10000 | C | 62.4 | D |
| Example 8 | Example 2 | | | | | | | | | |

*“Emulsifier Addition Rate” refers to an addition rate (parts by mass) with respect to 100 parts by mass of a chocolate base.

### 6. Structure Comparison Among Chocolates of Example and Comparative Example

(1) X-Ray Crystal Diffraction

The chocolate base (chocolate base for impregnation) of Example 21 and the chocolate base (chocolate base for impregnation) of Comparative Example 5 were subjected to X-ray crystal diffraction. Results are illustrated in FIG. 2. It is known that lactose (α-1 hydrate) has diffraction peaks appearing at 2θ of 19.0° and 19.9°. It was found that the chocolate base of Example 21 had a larger content rate of crystalline lactose (lactose (α-1 hydrate)) than the chocolate base of Comparative Example 5.

(2) Raman Imaging

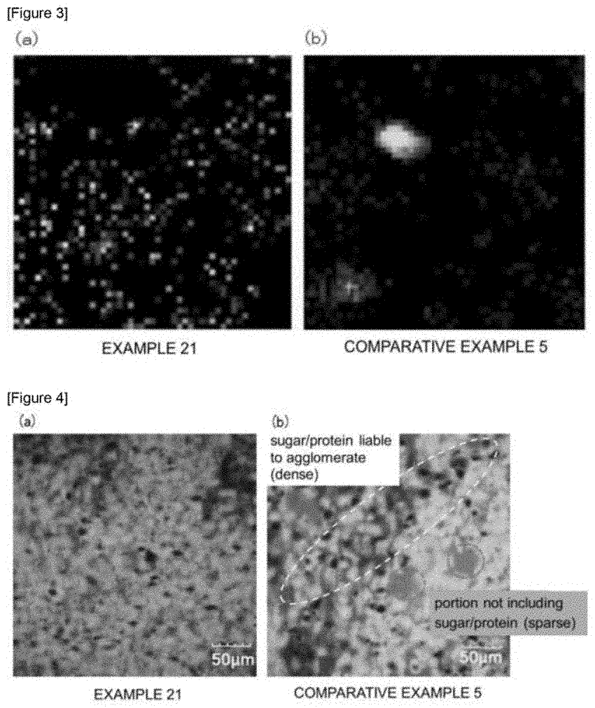

The chocolate base (chocolate base for impregnation) of Example 21 and the chocolate base (chocolate base for impregnation) of Comparative Example 5 were subjected to Raman imaging under the following measurement conditions. Results are illustrated in FIG. 3.

[Measurement Conditions]

Excitation wavelength: 532.07 nm

Excitation powder: 6.19 mW

Grating: 300 gr/mm

Slit width: 50 μm

Exposure time: 0.5 sec

Averaging: 2

Objective lens: ×20/NA 0.45

Measurement mode: XY mapping

Measurement region: 104 μm×102 μm

Pixel size: 2 μm×2 μm

Measurement time: 46 min 36 sec

In FIG. 3, a portion that looks bright corresponds to lactose. It is understood that lactose is dispersed in Example 21 (FIG. 3(a)) while lactose is in a lump form in Comparative Example 5 (FIG. 3(b)). A content rate of crystalline lactose estimated based on the image is 36.6% in Example 21 and 16.1% in Comparative Example 5 (assuming that a sum (total area) of sugar, lactose and a fat content is 100%). Although this was observation of a local structure, it was found that crystalline lactose is increased in the content to be widely dispersed over the structure by performing heat-holding and stirring at a temperature of 50° C. or more.

(3) Form Observation with Confocal Laser Microscope (CLSM)

The chocolate base (chocolate base for impregnation) of Example 21 and the chocolate base (chocolate base for impregnation) of Comparative Example 5 were subjected to form observation with a confocal laser microscope (CLSM). Results are illustrated in FIG. 4.

Although this was observation of a local structure, it was found that sugar and protein are homogeneously and widely dispersed in the structure in Example 21 (FIG. 4(a)) having been subjected to heat-holding and stirring at a temperature of 50° C. or more as compared with that in Comparative Example 5 (FIG. 4(b)).

### 7. Influence of Order of Heating Stirring Treatment and Refining Step

### Example 27

In manufacture of a chocolate described below, a heating stirring treatment was performed after a refining step in a manufacture method A. On the other hand, the refining step was performed after the heating stirring treatment in a manufacture method B. Influence derived from such a difference in the order was examined.

<Manufacture Method A>

Raw materials shown in Table 11 were respectively provided and mixed by an ordinary method in accordance with Compositions 7 to 9 shown in Table 11 (with a water content in mixing the raw materials set to 2.5% by mass), each of the resultant mixtures was roll milled and subjected to conching to prepare a chocolate base. Subsequently, the chocolate base in a paste state was stirred for 1 hour with the temperature held at 50 to 55° C. (target temperature: 53° C.). Then, the resultant chocolate base was filed in a mold, and the resultant was solidified by cooling to obtain a chocolate.

<Manufacture Method B>

Raw materials shown in Table 11 were respectively provided and mixed in accordance with Compositions 7 to 9 shown in Table 11 (with a water content in mixing the raw materials set to 2.5% by mass) stirred for 1 hour with the temperature held at 50 to 55° C. (target temperature: 53° C.) to obtain mixtures. Subsequently, each of the mixtures was roll milled and subjected to conching to prepare a chocolate base. Then, the resultant chocolate base was filled in a mold, and the resultant was solidified by cooling to obtain a chocolate.

TABLE 11

| | Composition | Composition | Composition |
|---|---|---|---|
| | 7 | 8 | 9 |
| | Mixing Rate | Mixing Rate | Mixing Rate |
| Raw Material | (mass %) | (mass %) | (mass %) |
| Sugar | 23.73 | 20.59 | 21.85 |
| Whole Milk Powder | 6.12 | 16.54 | 17.55 |
| Cacao Mass | 17.45 | 17.13 | 18.17 |
| Oil and Fat (including cocoa | 31.69 | 27.51 | 23.09 |
| butter and vegetable oils | | | |
| and fats, etc.) | | | |
| Whey Protein | 11.53 | 10.00 | 10.61 |
| Skim Milk Powder | 8.43 | 7.31 | 7.76 |
| Others (including | 1.05 | 0.92 | 0.97 |
| emulsifier and flavor, etc.) | | | |
| Total | 100.00 | 100.00 | 100.00 |
| Protein Content | 13.34 | 14.26 | 15.13 |
| Nonfat Milk Solid Content | 20.71 | 25.81 | 27.39 |

<Test Methods and Results>

(1) Change Over Time of Viscosity

Each of a chocolate on a manufacture day (0 day), a chocolate caused to stand still for 1 day in an incubator at 50° C. (1 day) and a chocolate caused to stand still for 7 days in an incubator at 50° C. (7 day) was measured for a viscosity at 40° C. with a B type viscometer. Results are shown in Table 12.

TABLE 12

| | | 0 day | 1 day | 7 day |
|---|---|---|---|---|
| Composition 7 | Manufacture | 12500 mPa · s | 12500 mPa · s | 12500 mPa · s |
| | Method A | | | |
| | Manufacture | 16250 mPa · s | 20000 mPa · s | 22500 mPa · s |
| | Method B | | | |
| Composition 8 | Manufacture | 13750 mPa · s | 13750 mPa · s | 15000 mPa · s |
| | Method A | | | |
| | Manufacture | 18750 mPa · s | 31250 mPa · s | 32500 mPa · s |
| | Method B | | | |
| Composition 9 | Manufacture | 23750 mPa · s | 26250 mPa · s | 28750 mPa · s |
| | Method A | | | |
| | Manufacture | 33750 mPa · s | 52500 mPa · s | 55000 mPa · s |
| | Method B | | | |

(2) Change Over Time of Yield Value

Each of a chocolate on a manufacture day (0 day), a chocolate caused to stand still for 1 day in an incubator at 50° C. (1 day) and a chocolate caused to stand still for 7 days in an incubator at 50° C. (7 day) was subjected to measurement with an E type viscometer (manufactured by Toki Sangyo Co., Ltd., “RE-85U”) under the following measurement conditions to calculate a yield value (Casson yield value: all yield values mentioned herein being Casson yield values) at 40° C. Results are shown in Table 13.

<Measurement Conditions>

Rotor: 1°34′×R24

Measurement temperature: 40° C.

Rotational speed: 0.5, 1.0, 2.5, 5.0, 10, 20, 50 or 100 rpm

Measurement time: 8.5 min

TABLE 13

| | | 0 day | 1 day | 7 day | |
|---|---|---|---|---|---|
| Composition 7 | Manufacture | 1.3 Pa | 3.3 Pa | 4.5 | Pa |
| | Method A | | | | |
| | Manufacture | 5.2 Pa | 8.9 Pa | 11.2 | Pa |
| | Method B | | | | |
| Composition 8 | Manufacture | 4.0 Pa | 3.9 Pa | 5.6 | Pa |
| | Method A | | | | |
| | Manufacture | 4.5 Pa | 10.0 Pa | 13.1 | Pa |
| | Method B | | | | |
| Composition 9 | Manufacture | 4.4 Pa | 6.0 Pa | 6.6 | Pa |
| | Method A | | | | |
| | Manufacture | 7.3 Pa | 15.5 Pa | 21.6 | Pa |
| | Method B | | | | |

(3) Sensory Evaluation

Each of a chocolate on a manufacture day (0 day) and a chocolate caused to stand still for 7 days in an incubator at 50° C. (7 day) was evaluated by a panel of one chocolate expert having been sufficiently trained to be able to give the same score to the same sample. The chocolate was put in the mouth, and stickiness and a protein odor (milk protein odor) felt in the mouth after the chocolate was melted in the mouth while being chewed several times were sensory evaluated in accordance with the following evaluation criteria. Results are shown in Table 14.

[Evaluation Criteria for Stickiness in Mouth]

A: not felt at all

B: substantially not felt

C: rather felt

D: felt rather strongly

E: felt strongly

[Evaluation Criteria for Protein Odor (Milk Protein Odor)]

A: not felt at all

B: substantially not felt

C: rather felt

D: felt rather strongly

E: felt strongly

In the above-described evaluation criteria, A to D are in a range causing no problems in practical use.

TABLE 14

| | | | Stickiness | Protein | |
|---|---|---|---|---|---|
| | | | in Mouth | Odor | Note |
| 0 | Composition 7 | Manufacture | A | A | |
| day | | Method A | | | |
| | | Manufacture | B | B | |
| | | Method B | | | |
| | Composition 8 | Manufacture | A | A | |
| | | Method A | | | |
| | | Manufacture | A | C | protein odor felt at the end, |
| | | Method B | | | and strangeness felt |
| | Composition 9 | Manufacture | A | B | |
| | | Method A | | | |
| | | Manufacture | B | C | protein odor felt at the end, |
| | | Method B | | | and strangeness felt |
| 7 | Composition 7 | Manufacture | A | A | |
| day | | Method A | | | |
| | | Manufacture | C | C | protein odor felt at the end, |
| | | Method B | | | and strangeness felt |
| | Composition 8 | Manufacture | B | A | |
| | | Method A | | | |
| | | Manufacture | C | D | protein odor strongly felt at |
| | | Method B | | | the end |
| | Composition 9 | Manufacture | B | B | |
| | | Method A | | | |
| | | Manufacture | D | D | protein odor strongly felt at |
| | | Method B | | | the end |

<Evaluation>

It is understood, from Tables 12 and 13, that increase of the viscosity and the yield value after storage can be further inhibited in employing the manufacture method A in which the heating stirring treatment was performed after the refining step as compared with in employing the manufacture method B in which the refining step was performed after the heating stirring treatment. Such an effect was more remarkable as the protein content (or the nonfat milk solid content) was larger in the order of Compositions 7, 8 and 9.

Besides, it is understood, from Table 14, that stickiness was less felt in the mouth and a protein odor was further inhibited even after storage in employing the manufacture method A as compared with in employing the manufacture method B. Such an effect was also more remarkable as the protein content (or the nonfat milk solid content) was larger in the order of Compositions 7, 8 and 9.

It is understood, based on these results, that the viscosity increase otherwise caused in storage (particularly, static storage) and pipe clogging are further inhibited and a flavor of oily confectionery can be made further better in employing the manufacture method A than in employing the manufacture method B.

Some embodiments and/or Examples of the invention have been described in detail, and those skilled in the art can easily make many changes and modifications in these exemplified embodiments and/or Examples without substantially departing from the novel teaching and effects of the invention. Accordingly, these many changes and modifications are embraced in the scope of the invention.

The entire contents of all the literature mentioned herein and the application from which the benefit of priority claims under the Paris Convention are incorporated herein by reference.

1. A method for manufacturing oily confectionery, comprising:
a stirring step of stirring an oily confectionery base for 1 hour or more with a temperature of the oily confectionery base being held at 50° C. or more and 60° C. or less, the oily confectionery base comprising 10% by mass or more of a milk protein or 20% by mass or more of a nonfat milk solid content.

2. The method for manufacturing oily confectionery according to claim 1, wherein the milk protein is not subjected to an enzymatic treatment.

3. The method for manufacturing oily confectionery according to claim 1, wherein the oily confectionery base comprises 3% by mass or more of amorphous lactose.

4. The method for manufacturing oily confectionery according to claim 1, wherein the oily confectionery base comprises 10% by mass or more of amorphous lactose.

5. The method for manufacturing oily confectionery according to claim 1, wherein the oily confectionery base comprises 14% by mass or more of the milk protein.

6. The method for manufacturing oily confectionery according to claim 1, wherein the oily confectionery base comprises 24% by mass or more of the nonfat milk solid content.

7. The method for manufacturing oily confectionery according to claim 1, wherein, in the stirring step, the temperature of the oily confectionery base is held at 50° C. or more and 55° C. or less.

8. The method for manufacturing oily confectionery according to claim 1, wherein, in the stirring step, the oily confectionery base in an amount of 3.2 t to 4.0 t is stirred in one bath.

9. The method for manufacturing oily confectionery according to claim 1, wherein the oily confectionery base is a chocolate base.

10. The method for manufacturing oily confectionery according to claim 1, further comprising, prior to the stirring step, a refining step of refining the oily confectionery base.

11. An oily confectionery, manufactured by the method for manufacturing oily confectionery according to claim 1.

12. The oily confectionery according to claim 11, wherein the oily confectionery has a viscosity of 49000 mPa·s or less after standing still at 50° C. for 24 hours.

13. The oily confectionery according to claim 11, wherein an increase of a viscosity of the oily confectionery is 20000 mPa·s or less after standing still at 50° C. for 24 hours.

14. The oily confectionery according to claim 11, wherein the oily confectionery has a yield value of 20.0 Pa or less after standing still at 50° C. for 24 hours.

15. The oily confectionery according to claim 11, wherein an increase of a yield value of the oily confectionery is 10.0 Pa or less after standing still at 50° C. for 24 hours.

16. An oily confectionery, comprising:
10% by mass or more of a milk protein or 20% by mass or more of a nonfat milk solid content,
wherein the oily confectionery has a viscosity of 49000 mPa·s or less after standing still at 50° C. for 24 hours.

17. The oily confectionery according to claim 16, wherein an increase of a viscosity of the oily confectionery is 20000 mPa·s or less after standing still at 50° C. for 24 hours.

18. The oily confectionery according to claim 16,
wherein the oily confectionery has a yield value of 20.0 Pa or less after standing still at 50° C. for 24 hours.

19. The oily confectionery according to claim 16, wherein an increase of a yield value of the oily confectionery is 10.0 Pa or less after standing still at 50° C. for 24 hours.

20. The oily confectionery according to claim 16, wherein the milk protein is not subjected to an enzymatic treatment.

21. The oily confectionery according to claim 16, wherein the oily confectionery comprises 14% by mass or more of the milk protein.

22. The oily confectionery according to claim 16, wherein the oily confectionery comprises 24% by mass or more of the nonfat milk solid content.

23. The oily confectionery according to claim 16, wherein the oily confectionery is a chocolate.

24. A method for inhibiting viscosity increase and/or poor meltability occurring in remelting an oily confectionery base containing 10% by mass or more of a milk protein or 20% by mass or more of a nonfat milk solid content, comprising:
a stirring step of stirring the oily confectionery base for 1 hour or more with a temperature of the oily confectionery base being held at 50° C. or more and 60° C. or less.
